(19) United States
(12) Patent Application Publication
(10) Pub. No.: US 2007/0201118 A1
(43) Pub. Date: Aug. 30, 2007

(54) Optical Waveguide Type Holographic Memory

(75) Inventors: Takashige Omatsu, Kanagawa (JP); Katsuyoshi Hoshino, Chiba (JP); Kenji Harada, Hokkaido (JP); Masahide Itoo, Ibaraki (JP); Toyohiko Yatagai, Chiba (JP)

Correspondence Address: RADER FISHMAN & GRAUER PLLC, LION BUILDING, 1233 20TH STREET N.W., SUITE 501, WASHINGTON, DC, 20036, US

(73) Assignee: Japan Science and Technology Agency, Saitama (JP)

(21) Appl. No.: 10/592,373

(22) PCT Filed: Mar. 9, 2005
(86) PCT No.: PCT/JP05/04592

§ 371 Date: Sep. 11, 2006

(30) Foreign Application Priority Data
Mar. 12, 2004 (JP) 2004-70657

(51) Int. Cl. G03H 1/26

(52) U.S. Cl. 359/22

(57) ABSTRACT

A multi-layered azobenzene polymer thin film layer (8) is formed on a substrate (1). Holograms are recorded on each of the azobenzene polymer thin films (1, 2, 3, 4, . . . ) of the azobenzene polymer layer (8) after forming two-dimensional surface reliefs by photoisomerization. To read the recorded information, infrared rays are irradiated from a laser source (9) through the selected azobenzene polymer thin films of the azobenzene polymer layer (8) via a cylindrical lens (10). The memory contents of the selected hologram (11) are read under visible light for reproduction. Wavelength conversion, amplification and other functions can be added. The optical waveguide type holographic memory of this invention also makes it possible to increase the memory capacity simply by lamination.

### FIELD OF THE INVENTION

This invention relates to an optical waveguide type holographic memory that uses photoinduced surface reliefs. Specifically, this invention relates to a laminated holographic memory wherein high-polymer thin films are laminated while recording the photoinduced surface reliefs of high-polymer thin films as a hologram, and the resultant laminated device is used as a hologram memory.

### BACKGROUND ART

Conventional external memory media used in computers, information equipment and digital audio-visual equipment is typically a CD or a DVD. The maximum recording capacity of such memory media is at the gigabyte level at best. Memory devices with larger recording capacity are increasingly being required as the development of information equipment Holographic memory is expected to enable high recording capacity close to the terabyte level.

Existing holographic memory uses single crystals (e.g., lithium-niobate) or photopolymers. According to the Publication of Unexamined patent application Ser. No. 74665-2002, write rays for forming irregular surfaces are irradiated on the surface of a thin film of high-polymer compounds including the azobenzene structure and, at the same time, bias rays of roughly the same wavelength as the write rays are irradiated extensively encompassing the irradiation region of the write rays.

Conventional holographic memories using single crystals, such as lithium niobate, or photopolymers have disadvantages in their production cost and read speed. The holographic memory that forms irregular surfaces on the thin film of high-polymer compounds including the azobenzene structure is designed simply to irradiate the rays from above to read the memory, and it is impossible to add functions and increase memory capacity by lamination. The recorded hologram often vanishes if intense visible light is directly irradiated on the azobenzene. With a view to solving these conventional problems, this invention has an object to provide a novel optical waveguide type holographic memory capable of wavelength conversion, wavelength amplification and increased memory capacity by lamination.

### DISCLOSURE OF THE INVENTION

The first invention of this application relates to an optical waveguide type holographic memory that uses as the hologram memory two-dimensional surface reliefs formed by photoisomerization on an azobenzene or other high-polymer thin film that is deposited on a substrate, wherein the memory contents are read under visible light for reproduction by irradiating infrared rays through said high-polymer thin film.

The second invention relates to an optical waveguide type holographic memory that uses as the hologram memory two-dimensional surface reliefs formed by photoisomerization on an azobenzene or other high-polymer thin film that is deposited on a substrate, wherein the memory contents are read under visible light for reproduction only by externally irradiating infrared rays.

The third invention relates to an optical waveguide type holographic memory that uses as the hologram memory multiple-laminated two-dimensional surface reliefs formed by photoisomerization on multiple azobenzene or other high-polymer thin films which are deposited on a substrate, wherein the desired memory contents are read under visible light for reproduction by selectively irradiating infrared rays through the respective high-polymer thin films.

The fourth invention relates to an optical waveguide type holographic memory that uses as the hologram memory two-dimensional surface reliefs formed by photoisomerization on multiple azobenzene or other high-polymer thin films which are deposited on a substrate, wherein the additives for amplifying the infrared rays are doped into the region of said hologram memory, and wherein an external excitation light is illuminated to read the memory contents after amplification under visible light for reproduction by irradiating infrared rays through said high-polymer thin films.

The fifth invention relates to an optical waveguide type holographic memory wherein two azobenzene high-polymer thin films, which are deposited on a substrate and which contain different hologram-recorded two-dimensional image data formed by photoisomerization, are placed above and below a buffer layer to form a laminated device, wherein the additives for amplifying infrared rays are doped into said buffer layer, and wherein an external excitation light is illuminated to read the memory contents after amplification under visible light for reproduction by irradiating infrared rays through said high-polymer thin films.

The sixth invention relates to the optical waveguide type holographic memory of the fourth or the fifth invention wherein said additives are a fluorescent dye, rare-earth ion or rare-earth metal complex.

The seventh invention relates to an optical waveguide type holographic memory wherein the azobenzene is oriented by corona poling in the hologram memory of the two-dimensional surface relief formed by photoisomerization on an azobenzene or other high-polymer thin film that is deposited on a substrate, and wherein the wavelength-converted memory contents are read under visible light for reproduction by irradiating infrared rays through said high-polymer thin film.

### EFFECTS OF THE INVENTION

This invention provides an optical waveguide type holographic memory that uses photoinduced surface reliefs. Azobenzene or other high-polymer thin films are deposited on a substrate and two-dimensional surface reliefs that are formed on the high-polymer thin film by photoisomerization are used as the hologram memory. The retrieved memory contents are reproduced under visible light. This invention also provides a laminated optical waveguide type holographic memory wherein high-polymer thin films are laminated while recording the photoinduced surface reliefs of the high-polymer thin film as a hologram to use the lamination as the hologram memory. The recorded hologram memory is reproduced by guiding light to the respective thin films of the laminated device.

Compared with conventional laminated holographic memory, the corona-poled azobenzene of the optical waveguide type holographic memory of this invention exhibits second-order nonlinear optical behavior. Using this feature, infrared rays are irradiated on the azobenzene as the hologram read light to visualize images of half the wavelength of the infrared rays. The recorded hologram conventional laminated holographic memory will vanish if an intense visible light is directly irradiated on the azobenzene but, using the method of this invention, the recorded hologram can be read without destruction because the light that is directly irradiated on the hologram comprises infrared rays.

Furthermore, the reproduced image is visible although infrared rays are used to read the image. Because of this visibility, a general-purpose silicon-based light detector such as a CCD can be used to read the data. This enhances the detection sensitivity of the reproduction signal considerably and makes it possible to design a compact and inexpensive optical reader.

Azobenzene accepts the dispersion of additives such as laser dye, rare-earth metal complex, and dendrimer. Azobenzene itself amplifies the intensity of the infrared rays that are used to read the data because these additives amplify light when they are photoexcited. Generally, the efficiency of azobenzene for generating visible reproduction light from infrared rays is proportional to the intensity of the infrared rays irradiated. Accordingly, the light amplification function of azobenzene enhances the reproduction efficiency of the visible reproduction light.

It is known that the propagation speeds of infrared rays and the visible reproduction light of one-half the wavelength of the infrared rays are identical if the period of the recorded surface reliefs is set to a certain interval (quasi-phase matching). The efficiency of generating visible light for reproduction from infrared rays is increased dramatically.

It is possible to alternately laminate azobenzene layers and buffer layers (PMMA, polycarbonate, polyvinyl alcohol, etc.) to form a laminated holographic memory consisting of dozens of hologram memories that are layered. Compared with conventional laminated holographic memory, this reduces production cost and enhances mass production yield

Furthermore, all device manufacturing processes are performed in an atmospheric environment eliminating the need for vacuum piping systems and other specialized equipment. This invention makes the manufacturing of multi-layered films easier than before, enabling the production of inexpensive holographic memories at excellent cost performance and mass production yield.

### BRIEF DESCRIPTION OF THE DRAWINGS

FIG. 1 shows the basic structure of the azobenzene polymer thin film optical waveguide.

FIG. 2 shows the principle of recording the surface reliefs by the photoisomerization of the azobenzene polymers.

FIG. 3 illustrates the diffractive optical function of surface reliefs.

FIG. 4 illustrates the light amplification function of the azobenzene polymer thin film.

FIG. 5 describes the wavelength conversion function of the azobenzene polymer thin film.

FIG. 6 shows the structure of the optical waveguide type holographic memory.

FIG. 7 shows the structure of the waveguide type holographic memory with the amplification function.

FIG. 8 shows the structure of the waveguide type holographic memory with the wavelength conversion function.

FIG. 9 is a 3-D conceptual illustration of the optical waveguide type holographic memory.

### BEST MODE FOR IMPLEMENTING THE INVENTION

The embodiments of this invention are described referring to the accompanying drawings. FIG. 1 shows the basic structure of the azobenzene polymer thin film optical waveguide of this invention. The reference numeral 1 in FIG. 1 is a substrate made of silica glass, coming glass, plastic, acrylic materials, etc. An azobenzene or other high-polymer thin film (2) is deposited on that substrate (1) to a thickness of a few μm by spin coating or dipping to form an azobenzene polymer thin film optical waveguide. The light propagates through this azobenzene polymer thin film (guided light).

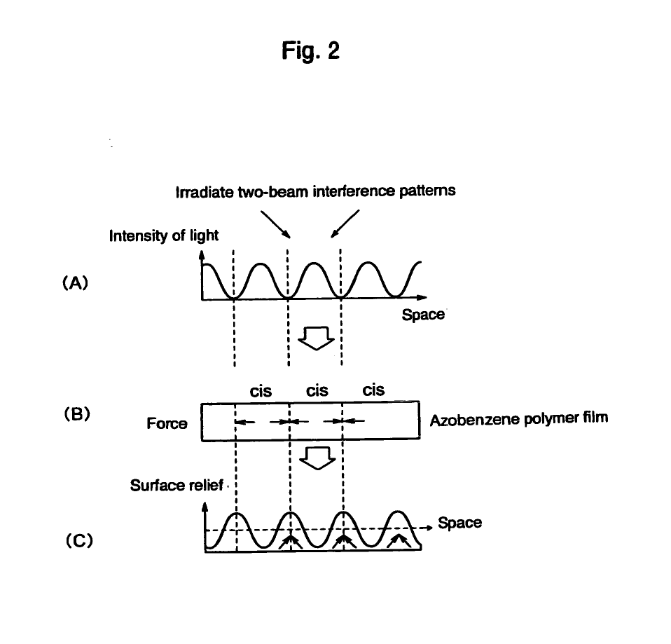

The principle of recording the surface reliefs on the azobenzene thin film optical waveguide by photoisomerization is described referring to FIG. 2. The two-beam interference patterns (FIG. 2(A)) containing the information to be recorded are irradiated on the azobenzene thin film (2) that is deposited on the substrate (1) (FIG. 2(B)). The polymers change to the cis configuration at the bright lines of light to form irregular surface reliefs according to the information being recorded as shown in FIG. 2(C).

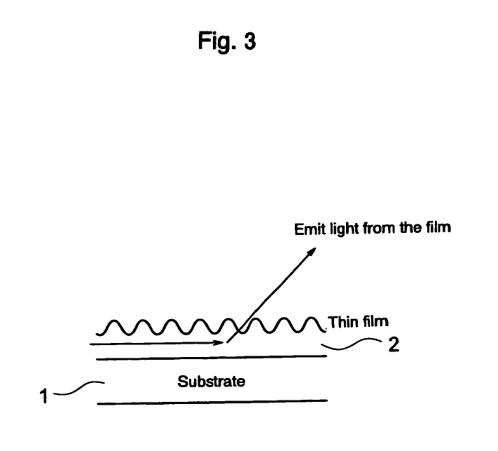

The diffractive optical function of the surface reliefs, as they are used in one dimension, is described referring to FIG. 3. When infrared rays are irradiated through the azobenzene polymer thin film (2) with the surface reliefs processed as shown in FIG. 2, the memory contents that are recorded as diffracted rays of visible light are reproduced from the azobenzene polymer thin film (2) as two-dimensional images. When reproducing the holograms, the reproduced images can also be detected by applying only infrared rays.

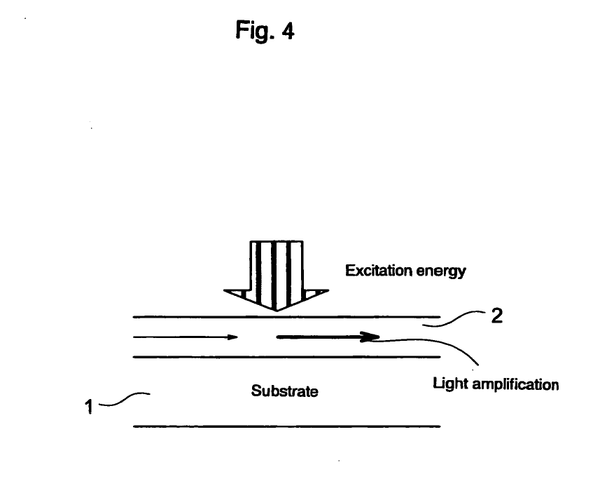

Light amplification of the azobenzene polymer thin film is described referring to FIG. 4. When the azobenzene polymer thin film (2) is deposited, additives such as laser dyes, rare-earth ions or rare-earth metal complexes are added in the amount of about 0.1 to 10% to the azobenzene polymers. The film is deposited by spin coating. An excitation energy is applied to this thin film. (The excitation energy is applied from above in this example, but it may also be applied from below.) The excitation energy may be applied from a light source or from an electric current through electrodes. When infrared rays are irradiated in this state through the azobenzene polymer thin film (2), amplified light is emitted to exhibit the light amplification function.

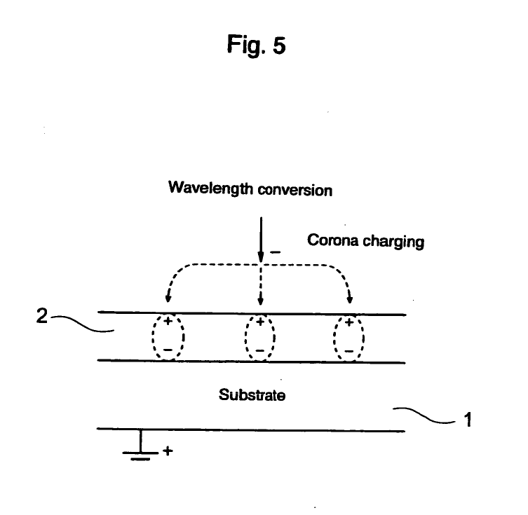

The wavelength conversion function (second-order nonlinear optical effect) of the azobenzene polymer thin film is described referring to FIG. 5. Positive (+) and negative (−) potentials are applied to the top and the bottom of the azobenzene polymer thin film. The polymers are polarized and oriented by corona charging to exhibit the second-order nonlinear optical effect as shown in FIG. 5. This is expressed by:
P=x⁽²⁾E²

From the above equation, if E˜exp(jωt), then P˜exp(j2ωt) or the optical frequency doubles to exhibit the wavelength conversion function to halve the wavelength of light.

The embodiments of the optical waveguide type holographic memory using the above functions of the azobenzene polymer thin film are described below.

### WORKING EXAMPLE 1

(1) Use as Optical Waveguide Type Holographic Memory

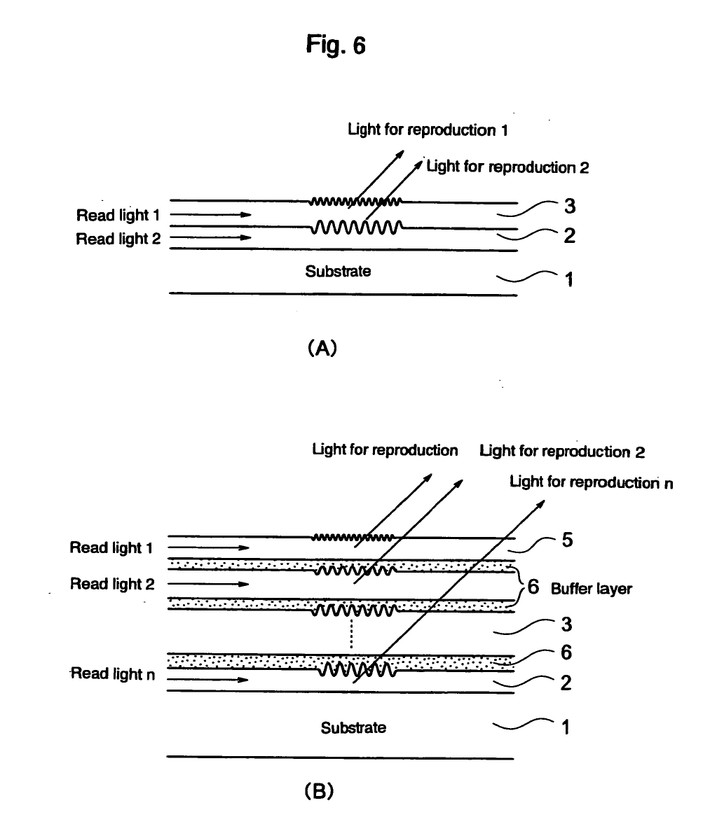

FIG. 6 shows optical waveguide type holographic memories as provided by this invention. FIGS. 6(A) and 6(B) show the structure of the two-layered and multi-layered holographic memory, respectively.

In FIG. 6(A), two azobenzene polymer layers (2) and (3), each a few μm thick, are deposited on the substrate (1) and different two-dimensional holographic image data is recorded on each of the layers. To reproduce the hologram, an infrared read light is coupled (guided) to the desired azobenzene layer. The reproduced image of the visible reproduction light (1) or (2) from the hologram is detected by a CCD camera and read as two-dimensional data.

At that time, the azobenzene layer serves as a waveguide for the read light. In addition, the reproduced image is shown under visible light. Accordingly, the sensitivity can be improved further when CCD cameras are used. It is necessary, in this example, to modulate the carrier frequency of the holograms so that the image is always reproduced at the same angle, even when the read wavelength is changed.

FIG. 6(B) shows a laminated device comprising the azobenzene polymer layers (2), (3), (4) and (5), each a few μm thick, that are deposited on the substrate 1. Each layer stores different two-dimensional hologram image data. The polymer layers are separated by the buffer layers (6) (PMMA, PVK, PC, etc.). Several dozens of layers can be laminated. To reproduce the holograms, a read light is coupled (guided) to the desired azobenzene layer. The image reproduced from the hologram is detected by a CCD camera and retrieved as two-dimensional data.

### WORKING EXAMPLE 2

(2) Use as Optical Waveguide Type Holographic Memory with Amplification Function

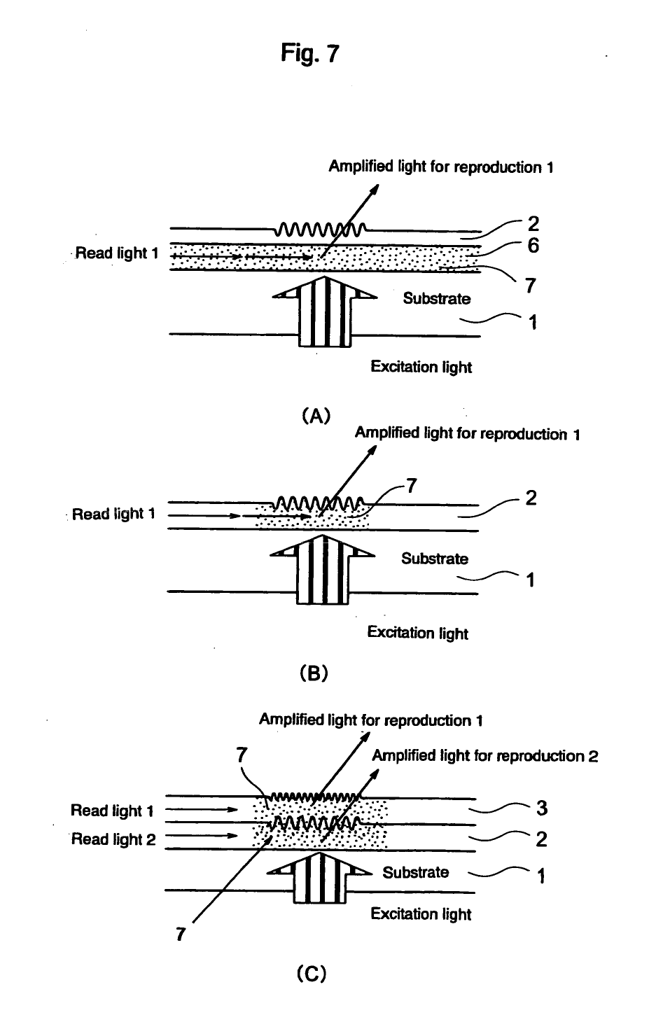

FIG. 7 shows optical waveguide type holographic memories with the amplification function as provided by this invention. FIG. 7(A) illustrates the structure of a single-layer optical waveguide type holographic memory with the amplification function. FIG. 7(B) shows the structure of a single-layer optical waveguide type holographic memory with the amplification function embedded in the buffer layer. FIG. 7(C) shows the structure of a two-layer optical waveguide type holographic memory with the amplification function.

In FIG. 7(A), an azobenzene polymer layer (2), a few μm thick, is deposited on the substrate (1) and the two-dimensional holographic image data are recorded by photoisomerization. The additive (7) for amplifying the infrared rays is doped into the hologram memory region of the two-dimensional surface reliefs and an excitation light is externally illuminated. Infrared rays are irradiated through the high-polymer thin film to read the memory contents under visible light for reproduction after amplification. The additives may be fluorescent dye, rare-earth ion or rare-earth metal complex.

In FIG. 7(B), an azobenzene polymer layer (2), a few μm thick, is deposited on the substrate (1) via a buffer layer (6). The additive (7) for amplifying infrared rays is doped into the buffer layer (6). An excitation light is externally illuminated and infrared rays are irradiated through the high-polymer thin film to read the memory contents under visible light for reproduction after amplification.

In FIG. 7(C), azobenzene or other high-polymer thin films (2) and (3) are deposited on the substrate (1). The two-dimensional surface reliefs formed on said thin films by photoisomerization are laminated to serve as a single hologram memory. The additive (7) for amplifying the infrared rays is doped into the surface relief region of the hologram memory and an excitation light is externally illuminated. Infrared rays are selectively irradiated through the laminated high-polymer thin films to read the desired memory contents under visible light for reproduction after amplification.

### WORKING EXAMPLE 3

(3) Use as Optical Waveguide Type Holographic Memory with Wavelength Conversion Function

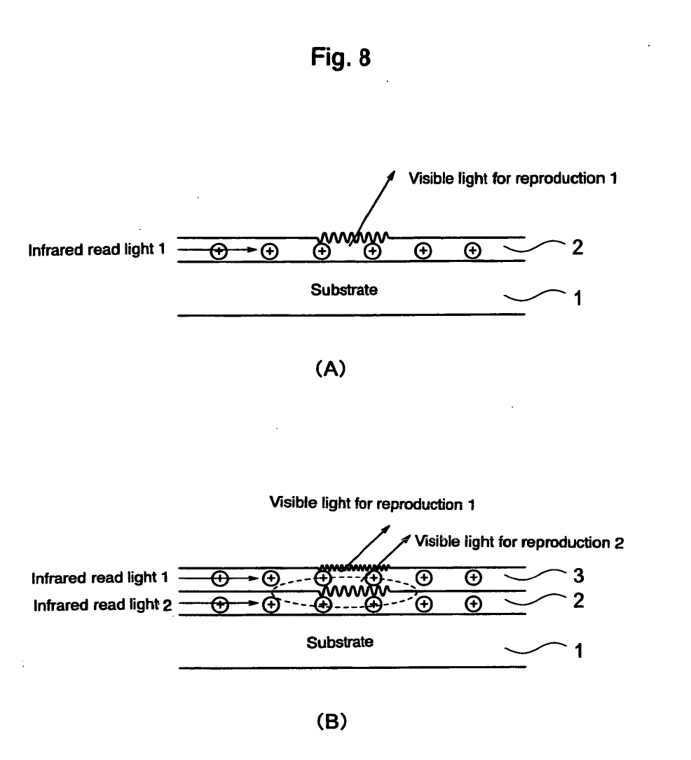

FIG. 8 shows the optical waveguide type holographic memories with the wavelength conversion function as provided by this invention. FIGS. 8(A) and 8(B) respectively show the structures of a single-layer and a two-layer optical waveguide type holographic memory with the wavelength conversion function.

In FIG. 8(A), the two-dimensional surface reliefs that are formed by photoisomerization on the azobenzene or other high-polymer thin films (2) and (3) are deposited on the substrate (1) to record the holograms. The two-dimensional surface reliefs are laminated to function as a single-layered hologram memory. After recording, the azobenzene is oriented by corona poling for the azobenzene polymers to convert infrared rays into visible light of one-half the wavelength (second harmonic activation). Infrared rays are irradiated through the high-polymer thin films and the memory contents are converted according to the wavelength to enable reading under visible light for reproduction.

It is possible to make the propagation speed of both the infrared rays and the visible light identical (phase matching) by appropriately setting the carrier frequency period for the holograms by adding spatial modulation signals to the surface reliefs to achieve quasi-phase matching. In this case, the wavelength is efficiently converted from infrared rays to the second harmonics, and as the reproduction light gets more intense, the detection sensitivity is improved. In addition, when the infrared rays are guided through the hologram-recorded azobenzene polymer layer for reading the data, the image is reproduced under visible light, and as a result the image can be detected with good sensitivity by CCD cameras.

In FIG. 8(B), the two-dimensional surface reliefs are formed by photoisomerization on the azobenzene or other high-polymer thin film (2) that is deposited on the substrate (1) to record the holograms. After the holograms are recorded, the azobenzene is oriented by corona poling for the azobenzene polymers to convert the infrared rays into visible light of one-half the wavelength (second harmonic activation). Infrared rays are selectively irradiated through the respective high-polymer thin films and the desired memory contents are converted according to the wavelength to enable reading under visible light for reproduction.

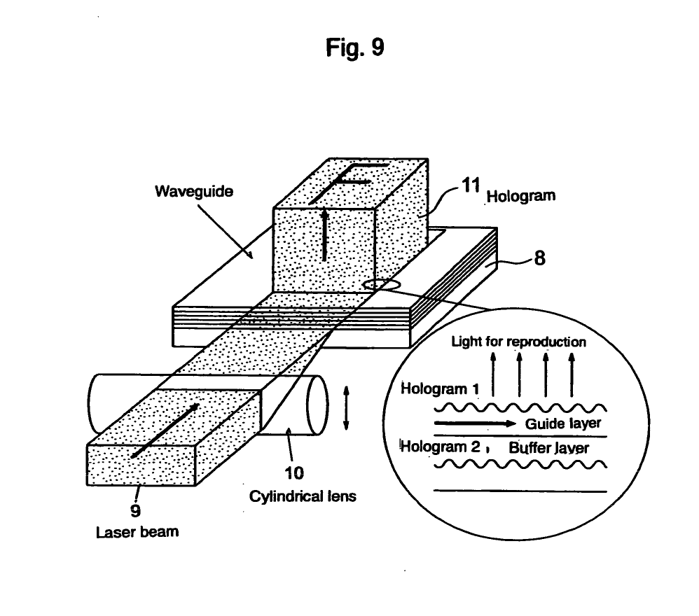

FIG. 9 is a 3-D conceptual illustration of the optical waveguide type holographic memory. A multi-layered azobenzene polymer layer (8) is deposited on the substrate (1). Each of the deposited azobenzene polymer thin films (1, 2, 3, 4, . . . ) of the multi-layered azobenzene polymer layer (8) has two-dimensional surface reliefs formed by photoisomerization for recording holograms.

To read the recorded information, infrared rays are irradiated from the laser source (9) through the selected azobenzene polymer thin film of the multi-layered azobenzene polymer layer (8) via a cylindrical lens (10). The memory contents of the selected hologram (11) are read under visible light for reproduction.

As typically represented by the above-mentioned embodiments, the optical waveguide type holographic memory of this invention reproduces images under visible light by guiding infrared rays through the hologram-recorded azobenzene polymer layer. It is therefore possible to detect the images with good sensitivity using CCD cameras, create a detection system that is compact in size and low in price, and increase the recording capacity by laminating holograms.

### INDUSTRIAL APPLICABILITY

As described in the above details, the optical waveguide type holographic memory of this invention provides an optical memory with a recording capacity close to terabyte level and its ripple effects throughout industry can be immense. For example, this invention can be used as a memory in information equipment and as the ROM function in computers. When used in audio-visual equipment, a full-length movie may be stored on a single disc for real reproduction in a home cinema environment. As such, the industrial applicability of this invention is very wide.

1. An optical waveguide type holographic memory that uses as the hologram memory two-dimensional surface reliefs formed by photoisomerization on an azobenzene or other high-polymer thin film that is deposited on a substrate, wherein the memory contents are read under visible light for reproduction by irradiating infrared rays through said high-polymer thin film.

2. An optical waveguide type holographic memory that uses as the hologram memory two-dimensional surface reliefs formed by photoisomerization on an azobenzene or other high-polymer thin film that is deposited on a substrate, wherein the memory contents are read under visible light for reproduction by externally irradiating infrared rays only.

3. An optical waveguide type holographic memory that uses as the hologram memory multiple-laminated two-dimensional surface reliefs formed by photoisomerization on azobenzene or other high-polymer thin films that are deposited on a substrate, wherein the desired memory contents are read under visible light for reproduction by selectively irradiating infrared rays through respective high-polymer thin films.

4. An optical waveguide type holographic memory that uses as the hologram memory two-dimensional surface reliefs formed by photoisomerization on azobenzene or other high-polymer thin films that are deposited on a substrate, wherein the additives for amplifying infrared rays are doped into the region of said hologram memory, and wherein an external excitation light is illuminated to read the memory contents after amplification under visible light for reproduction by irradiating infrared rays through said high-polymer thin films.

5. An optical waveguide type holographic memory wherein two azobenzene high-polymer thin films, that are deposited on a substrate and contain different hologram-recorded two-dimensional image data formed by photoisomerization, are placed above and below a buffer layer to form a laminated device, wherein the additives for amplifying the infrared rays are doped into said buffer layer, and wherein an external excitation light is illuminated to read the memory contents after amplification under visible light for reproduction by irradiating infrared rays through said high-polymer thin films.

6. The optical waveguide type holographic memory according to said claim 4 or 5 wherein said additives are fluorescent dye, rare-earth ion or rare-earth metal complex.

7. An optical waveguide type holographic memory wherein azobenzene is oriented by corona poling in the hologram memory region of the two-dimensional surface relief formed by photoisomerization on the azobenzene or other high-polymer thin film that is deposited on a substrate, and wherein the wavelength-converted memory contents are read under visible light for reproduction by irradiating infrared rays through said high-polymer thin film.
